(19) United States
(12) Patent Application Publication
(10) Pub. No.: US 2026/0161312 A1
(43) Pub. Date: Jun. 11, 2026

(54) SOLID STATE DRIVE AND MEMORY MODE SWITCHING METHOD

(71) Applicant: GIGA-BYTE TECHNOLOGY CO., LTD., New Taipei City (TW)

(72) Inventors: Sheng-Liang KAO, New Taipei City (TW); Huayi WU, New Taipei City (TW); Shang-Ji HE, New Taipei City (TW); Ruei-Wun LIN, New Taipei City (TW)

(73) Assignee: GIGA-BYTE TECHNOLOGY CO., LTD., New Taipei City (TW)

(21) Appl. No.: 19/407,997

(22) Filed: Dec. 3, 2025

(30) Foreign Application Priority Data
Dec. 5, 2024 (TW) 113147109

(51) Int. Cl. G06F 3/06

(52) U.S. Cl. CPC G06F 3/0634; G06F 3/0604; G06F 3/0679

(57) ABSTRACT

The present disclosure provides a solid state drive and memory mode switching method. The memory mode switching method is adapted to a memory, the memory mode switching method is performed by a controller and includes: receiving a user command, wherein the user command designates a designated operation mode of the memory, formatting a storage space of the memory according to the user command, and switching a current operation mode of the storage space into the designated operation mode after the formatting.

This non-provisional application claims priority under 35 U.S.C. § 119(a) on Patent Application No(s). 113147109 filed in Republic of China (Taiwan) on Dec. 5, 2025, the entire contents of which are hereby incorporated by reference.

### BACKGROUND

### 1. Technical Field

This disclosure relates to a solid state drive and memory mode switching method.

### 2. Related Art

Currently, most commercially available solid state drives adopt fixed mode settings, such as pseudo single-level cell (pSLC) and triple-level cell (TLC) modes. After shipment from the factory, the operation mode of the solid state drive cannot be changed by the user. When the used storage space of the solid state drive exceeds a specific threshold (for example, one-third of the capacity), the firmware of the solid state drive automatically switches from the pSLC mode to the TLC mode, causing the read/write speed and durability to decrease while the storage capacity increases. This automatic switching process cannot be controlled by the user, thereby limiting the balance between high performance and high storage density.

Such limitations cause users who require the memory to operate in a high-performance manner (such as gamers or creators) to only be able to choose expensive enterprise-grade solid state drives to meet their needs, and they are unable to switch the memory to a required operation mode according to their usage requirements.

### SUMMARY

Accordingly, this disclosure provides a solid state drive and memory mode switching method.

According to one or more embodiment of this disclosure, a memory mode switching method, adapted to a memory, is performed by a controller and includes: receiving a user command, wherein the user command designates a designated operation mode of the memory; formatting a storage space of the memory according to the user command; and switching a current operation mode of the storage space into the designated operation mode after the formatting.

According to one or more embodiment of this disclosure, a solid state drive includes: a memory and a controller. The memory has a storage space. The controller is connected to the memory, and is configured to: receive a user command, wherein the user command designates a designated operation mode of the memory; format a storage space of the memory according to the user command; and switch a current operation mode of the storage space into the designated operation mode after the formatting.

In view of the above description, according to one or more embodiments described above, the solid state drive and the memory mode switching method allow a user to switch the operation mode of the solid state drive according to actual requirements, so that the user may flexibly select a memory operation mode of the solid state drive that meets the user's needs and preferences (for example, the above pSLC, MLC, TLC, QLC, and PLC). Accordingly, the user may switch among different memory operation modes without replacing the hardware architecture of the solid state drive.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a solid state drive according to an embodiment of the present application;

FIG. 2 is a flow chart illustrating a memory mode switching method according to an embodiment of the present application;

FIG. 3 is a schematic diagram illustrating a user interface for switching the memory mode of the solid state drive according to an embodiment of the present application;

FIG. 4 is a block diagram illustrating a host and the solid state drive according to another embodiment of the present application; and

FIG. 5 is a flow chart illustrating storing warranty information in the memory mode switching method according to an embodiment of the present application.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

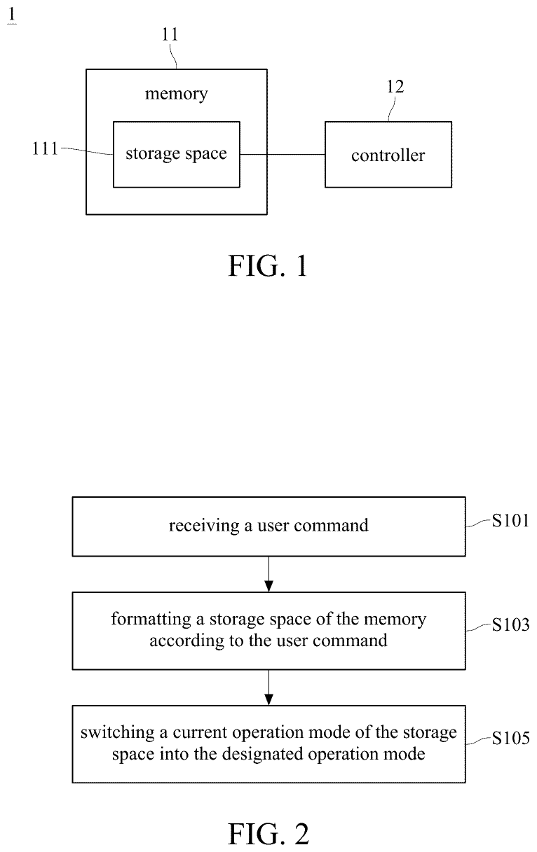

Please refer to FIG. 1, wherein FIG. 1 is a block diagram illustrating a solid state drive according to an embodiment of the present application. As shown in FIG. 1, the solid state drive 1 includes a memory 11 and a controller 12. The memory 11 is electrically connected to or in communication connection with the controller 12, and the memory 11 includes a storage space 111.

The memory 11 may be a flash memory. Further, the memory 11 may be a NAND flash memory. The memory 11 may include a plurality of flash chips, the flash chip may be composed of non-volatile storage units, and the storage space 111 may be a storage space composed of the non-volatile storage units. The memory 11 may be configured to store data, the present disclosure does not limit the content stored in the memory 11.

The controller 12 is configured to switch an operation mode of the memory 11 based on a user command. The controller 12 may include one or more processors, and said processor may be, for example, a central processing unit, a graphics processing unit, a microcontroller, a programmable logic controller, or other processors having signal processing functions.

Please refer to FIG. 1 and FIG. 2, wherein FIG. 2 is a flow chart illustrating a memory mode switching method according to an embodiment of the present application. The memory mode switching method shown in FIG. 2 may be applied to the solid state drive 1 of FIG. 1. As shown in FIG. 2, the memory mode switching method includes: step S101: receiving a user command; step S103: formatting a storage space of the memory according to the user command; and step S105: switching a current operation mode of the storage space into the designated operation mode.

In step S101, the controller 12 obtains the user command input by a user. The user command may be obtained by the controller 12 from a user interface of a host. The user command designates the designated operation mode of the memory 11. In other words, the designated operation mode is an operation mode of the memory 11 designated by the user.

In step S103, the controller 12 formats the storage space 111 of the memory 11 based on the user command. The controller 12 may be triggered by the user command to format the storage space 111 of the memory 11, thereby erasing data stored in the storage space 111. Further, the controller 12 may only erase accessible data (for example, data that is by default readable/accessible to the user), and keep system data (for example, data that is by default not readable/accessible to the user).

In step S105, after the formatting in step S103, the controller 12 switches the storage space 111 from the current operation mode to the designated operation mode of the user command. Further, the controller 12 may switch all storage spaces 111 of the memory 11 into the designated operation mode. In an embodiment, the current operation mode and the designated operation mode may be any two of candidate operation modes. The candidate operation modes may include multi-level cell (MLC) mode, triple-level cell (TLC) mode, quad-level cell (QLC) mode, penta-level cell (PLC) mode and pseudo single-level cell (pSLC) mode. In other words, the user command may be configured to switch one of the candidate operation modes (the current operation mode) of the memory 11 into another candidate operation mode (the designated operation mode).

For example, when high read/write speed and durability are required, the designated operation mode may be a pseudo single-level cell (pSLC) mode; when large capacity is required, the designated operation mode may be a multi-level cell (MLC) mode, a triple-level cell (TLC) mode, a quad-level cell (QLC) mode, or a penta-level cell (PLC) mode. In addition, when the storage space 111 is switched from the current operation mode to the designated operation mode, the capacity of the storage space 111 may also be correspondingly switched. For example, when the current operation mode is a pseudo single-level cell (pSLC) mode and the designated operation mode is a triple-level cell (TLC) mode, the capacity of the storage space 111 may be switched from 333 gigabytes (GB) to 1 terabyte (TB).

In an embodiment, step S105 may include the controller 12 selecting target firmware corresponding to the designated operation mode from a plurality of pieces of candidate firmware according to the designated operation mode, and executing the target firmware, thereby determining the number of storage bits of each memory cell operated in the designated operation mode. The pieces of candidate firmware may be respectively used to execute the multi-level cell (MLC) mode, the triple-level cell (TLC) mode, the quad-level cell (QLC) mode, the penta-level cell (PLC) mode, and the pseudo single-level cell (pSLC) mode, and the controller 12 may select the target firmware from the pieces of candidate firmware according to the designated operation mode.

According to one or more embodiments described above, the solid state drive and the memory mode switching method allow a user to switch the operation mode of the solid state drive according to actual requirements, so that the user may flexibly select a memory operation mode of the solid state drive that meets the user's needs and preferences (for example, the above pSLC, MLC, TLC, QLC, and PLC). Accordingly, the user may switch among different memory operation modes without replacing the hardware architecture of the solid state drive.

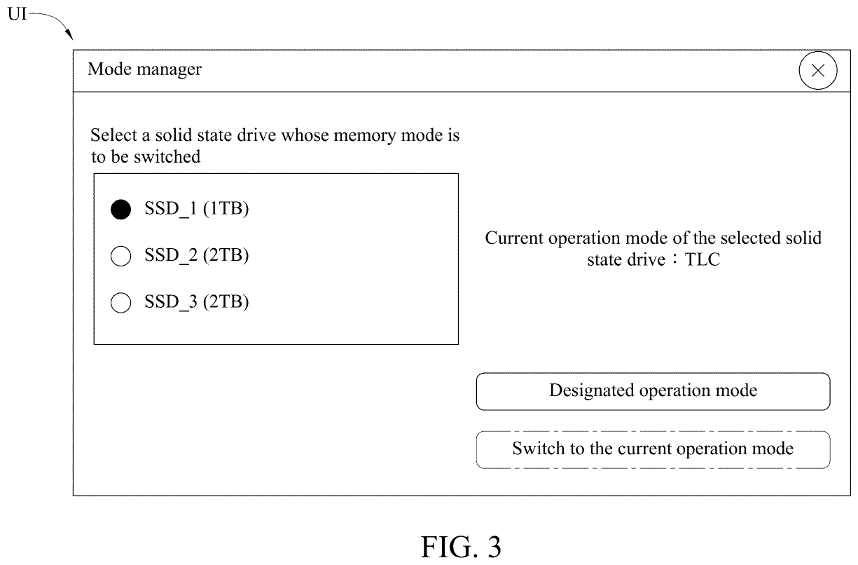

Please refer to FIG. 3, wherein FIG. 3 is a schematic diagram illustrating a user interface for switching the memory mode of the solid state drive according to an embodiment of the present application. The user interface UI shown in FIG. 3 may be presented at the host described above. As shown in FIG. 3, when a plurality of solid state drives are present, the user interface UI allows the user to select one of the solid state drives to switch the operation mode. The user interface UI may display the current operation mode of the selected solid state drive. Moreover, when the button of the “designated operation mode” on the user interface UI is triggered, the selected solid state drive may execute the above memory mode switching method to switch the current operation mode to the designated operation mode. It should be particularly noted that the user interface UI shown in FIG. 3 is merely an example and is not intended to limit the present disclosure.

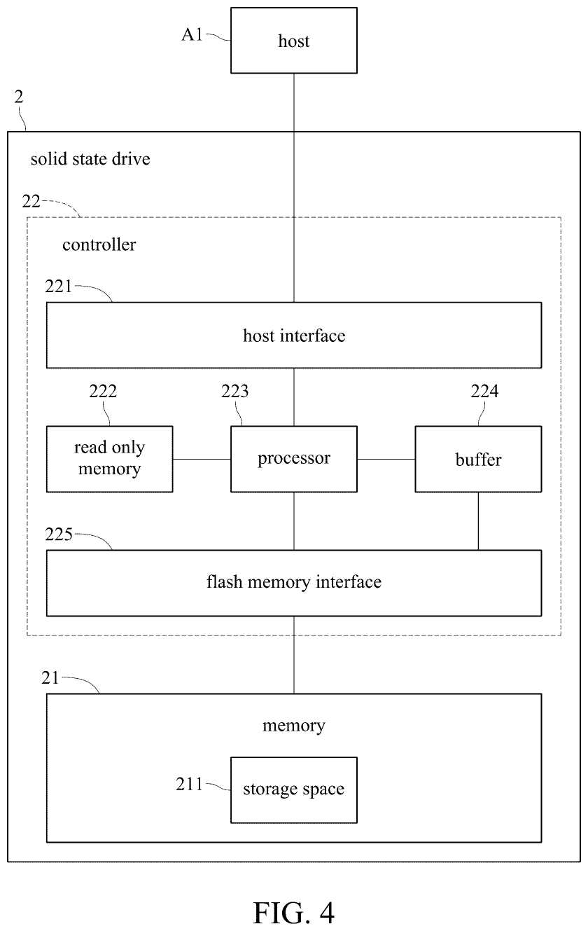

Please refer to FIG. 4, wherein FIG. 4 is a block diagram illustrating a host and the solid state drive according to another embodiment of the present application. As shown in FIG. 4, the solid state drive 2 includes a memory 21 and a controller 22. The memory 21 includes a storage space 211. The implementations of the memory 21 and the storage space 211 may be the same as that of the memory 11 and the storage space 111 of FIG. 1, their descriptions are not repeated herein.

The controller 22 includes a host interface 221, a read only memory 222, a processor 223, a buffer 224 and a flash memory interface 225. The host interface 221 is configured to be connected to a host A1, wherein the host A1 may be the host described above, and may be configured to display the user interface UI as shown in FIG. 3. The host interface 221 is further connected to the processor 223; the processor 223 is further connected to the read only memory 222, the buffer 224 and the flash memory interface 225; the flash memory interface 225 is further connected to the memory 21.

The host interface 221 may be configured to communicate with the host A1 to manage the read/write requests of the host A1, and receive the user command as described above from the host A1. The read only memory 222 may be configured to store the plurality of pieces of candidate firmware. The processor 223 may be configured to format the storage space 211 of the memory 21 according to the user command and execute the target firmware corresponding to the designated operation mode. The buffer 224 may be configured to temporarily store data to increase read/write speed. The flash memory interface 225 may be configured for communication between the controller 22 and the memory 21.

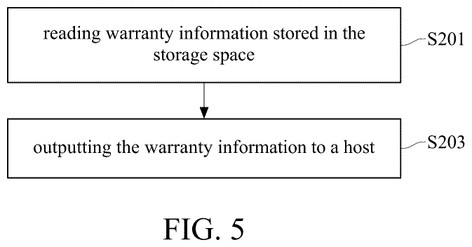

Please refer to FIG. 4 and FIG. 5, wherein FIG. 5 is a flow chart illustrating storing warranty information in the memory mode switching method according to an embodiment of the present application. It should be noted that the steps shown in FIG. 5 may also be performed by the solid state drive 1 of FIG. 1. The steps shown in FIG. 5 may be performed before formatting the storage space of the memory (step S103 of FIG. 2). Moreover, the steps shown in FIG. 5 may be performed between step S101 and step S103 of FIG. 2. As shown in FIG. 5, keeping the warranty information includes: step S201: reading warranty information stored in the storage space; and step S203: outputting the warranty information to a host.

In step S201, the controller 22 may read the warranty information of the solid state drive 2 from the storage space 211, wherein the above system data may include the warranty information. Furthermore, the processor 223 of the controller 22 may read the warranty information of the solid state drive 2 from the storage space 211 via the flash memory interface 225. The warranty information may include one or more of a serial number, a health status, a total number of data written by the host A1, a total number of data read by the host A1, a number of power-on times, and a power-on time duration of the solid state drive 2.

In step S203, the controller 22 may output the warranty information to the host A1. Furthermore, the processor 223 of the controller 22 may output the warranty information to the host A1 via the host interface 221. In one embodiment, the processor 223 may not store the warranty information in the buffer 224 and may directly output the warranty information to the host A1 via the host interface 221; in another embodiment, the processor 223 may first store the warranty information in the buffer 224 and then output the warranty information to the host A1 via the host interface 221.

According to the solid state drive and the memory mode switching method of one or more embodiments described above, by outputting the warranty information to the host before formatting the storage space and switching firmware, the problem of losing the warranty information due to formatting may be avoided.

In an embodiment, step S103 of FIG. 2 may include receiving a switch command from the host, wherein the switch command is generated by the host in response to the warranty information, and the formatting is performed after the switch command is received. The switch command may indicate that the warranty information has been received by the host A1. In other words, after the controller 22 outputs the warranty information to the host A1, the controller 22 may perform the formatting only after receiving the switch command from the host A1. By performing the formatting after receiving the switch command without dynamically adjusting a ratio among the candidate operation modes, garbage collection required for data migration may be eliminated, thereby avoiding a large number of program/erase (P/E) cycles that would otherwise affect the durability of the solid state drive.

Further, in an embodiment, the processor 223 may first encrypt the warranty information and output the encrypted warranty information to the host A1. In other words, the warranty information stored by the host A1 is encrypted information. The encryption processing may include one or more of a symmetric encryption algorithm, an asymmetric encryption algorithm, and a hash function, but the present disclosure does not limit the encryption processing method.

In addition, after step S105 of FIG. 2, the controller 22 may further request the warranty information from the host A1, so as to write the warranty information into the storage space 211 operating in the designated operation mode. Accordingly, the warranty information of the solid state drive 2 may be completely retained. Corresponding to the above embodiment in which the warranty information is encrypted, after the controller 22 obtains the warranty information from the host A1, the processor 223 of the controller 22 may first decrypt the warranty information and then write the decrypted warranty information into the storage space 211 corresponding to the designated operation mode.

It should be noted that the one or more embodiments described above may be implemented in combination.

In view of the above description, according to one or more embodiments described above, the solid state drive and the memory mode switching method allow a user to switch the operation mode of the solid state drive according to actual requirements, so that the user may flexibly select a memory operation mode of the solid state drive that meets the user's needs and preferences (for example, the above pSLC, MLC, TLC, QLC, and PLC). By performing the formatting after receiving the switch command without dynamically adjusting a ratio among the candidate operation modes, garbage collection required for data migration may be eliminated, thereby avoiding a large number of program/erase (P/E) cycles that would otherwise affect the durability of the solid state drive. Accordingly, the user may switch among different memory operation modes without replacing the hardware architecture of the solid state drive. By writing the warranty information into the storage space operating in the designated operation mode, the warranty information of the solid state drive may be completely retained.

What is claimed is:

1. A memory mode switching method, adapted to a memory, the memory mode switching method performed by a controller and comprising:
receiving a user command, wherein the user command designates a designated operation mode of the memory;
formatting a storage space of the memory according to the user command; and
switching a current operation mode of the storage space into the designated operation mode after the formatting.

2. The memory mode switching method according to claim 1, wherein switching the current operation mode of the storage space into the designated operation mode after formatting the storage space comprises:
selecting target firmware corresponding to the designated operation mode from a plurality of pieces of candidate firmware according to the designated operation mode; and
executing the target firmware.

3. The memory mode switching method according to claim 1, further comprising:
before formatting the storage space of the memory, reading warranty information stored in the storage space; and
outputting the warranty information to a host.

4. The memory mode switching method according to claim 3, wherein formatting the storage space of the memory comprises:
receiving a switch command from the host in response to the warranty information,
wherein the formatting is performed after receiving the switch command.

5. The memory mode switching method according to claim 3, further comprising:
after switching the current operation mode of the storage space into the designated operation mode, writing the warranty information into the storage space.

6. The memory mode switching method according to claim 3, wherein the warranty information stored by the host is encrypted information.

7. The memory mode switching method according to claim 1, wherein the current operation mode and the designated operation mode are any two of a multi-level cell mode, a triple-level cell mode, a quad-level cell mode, a penta-level cell mode and a pseudo single-level cell mode.

8. A solid state drive, comprising:
a memory having a storage space; and
a controller connected to the memory, and configured to:
receive a user command, wherein the user command designates a designated operation mode of the memory;
format the storage space of the memory according to the user command; and
switch a current operation mode of the storage space into the designated operation mode after the formatting.

9. The solid state drive according to claim 8, wherein the controller is configured to select target firmware corresponding to the designated operation mode from a plurality of pieces of candidate firmware according to the designated operation mode, and execute the target firmware.

10. The solid state drive according to claim 8, wherein the controller is further connected to a host, and before formatting the storage space of the memory, the controller is further configured to read warranty information stored in the storage space, and output the warranty information to the host.

11. The solid state drive according to claim 10, wherein the controller is configured to receive a switch command from the host in response to the warranty information, wherein the controller performs the formatting after receiving the switch command.

12. The solid state drive according to claim 10, wherein after switching the current operation mode of the storage space into the designated operation mode, the controller is further configured to write the warranty information into the storage space.

13. The solid state drive according to claim 10, wherein the warranty information stored by the host is encrypted information.

14. The solid state drive according to claim 8, wherein the current operation mode and the designated operation mode are any two of a multi-level cell mode, a triple-level cell mode, a quad-level cell mode, a penta-level cell mode and a pseudo single-level cell mode.
